(19) United States
(12) Patent Application Publication
(10) Pub. No.: US 2006/0251862 A1
(43) Pub. Date: Nov. 9, 2006

(54) Composite shaped block

(76) Inventor: Thomas Sievers, Boltersen (DE)

Correspondence Address: HEDMAN & COSTIGAN P.C., 1185 AVENUE OF THE AMERICAS, NEW YORK, NY, 10036, US

(21) Appl. No.: 10/541,101

(22) PCT Filed: Dec. 25, 2003
(86) PCT No.: PCT/DE03/04261

§ 371 Date: Apr. 24, 2006

(30) Foreign Application Priority Data
Dec. 31, 2002 (DE) 102 61 6922

(51) Int. Cl. B32B 3/00; E04B 1/16

(52) U.S. Cl. 428/172; 264/34

(57) ABSTRACT

The invention relates to a composite shaped block produced by placing a top plate serving as a covering layer onto a supporting body. This supporting body is provided with a binder compound and is produced by a shaping process. The invention also relates to a method for producing composite shaped blocks of this type.

The invention relates to a composite shaped block manufactured by applying an upper slab, as a covering top layer, to a support element provided with an agglomerant and manufactured by means of a shaping process, and a method for manufacturing such composite shaped blocks.

Shaped blocks, and particularly paving stones/paving elements, terrace and footpath slabs, are known in a variety of design forms. They are used for landscape gardening and also for strengthening surfaces that are walked and ridden on.

Natural stones are unique optical materials with long life and high prestige, characteristics which cannot be achieved with industrially produced concrete stone or concrete ashlar in the surface. Advantages of a natural stone include its high aesthetic value, a large variety of materials and the rich selection of colours, structures and qualities. Because of this an increasing number of architects, planners and owners are tending towards the use of natural stone products, even though they are much more expensive. However, some natural stone pavings, laid as a floor, suffer from the disadvantage that they form technically inferior useful surfaces, with lower load carrying capacity, than concrete stones or ashlars. Moreover, laying can often only be carried out by specialists, and not by machine. The following may therefore be mentioned as disadvantages: the high material and labour costs and the skill required to process the natural stone correctly, which in many cases cannot be found.

Concrete ashlars are manufactured from cement, quartz sand and additives. They are produced industrially and can be manufactured in any desired in any desired shape, at low cost, in large quantities and with low production tolerances. They have the advantage over sawn, smooth-walled natural stones that the flank surfaces (lateral surfaces) and laying side (base side) are rough because of the production process, which makes for better “grip” in the laying bed and when pointing. Because the material thickness and joint geometry are varied, they may be designed for high surface loads. Concrete stones or concrete ashlars can be laid easily and quickly by machine or by temporary workers and handymen. Due to the above-mentioned characteristics optimum technical useful surfaces can be manufactured at low cost, even for the highest loads, in contrast to the natural stone product.

One drawback, however, is that the desired natural stone optics are not generally achieved satisfactorily by structuring and colouring the concrete stone or concrete ashlar surfaces. Unlike natural stone products, the surfaces soil very quickly, or at least more quickly in most cases, and therefore have a much shorter service life, often only around 10 to 15 years, depending on use.

These structured concrete elements, e.g. with imitation granite surfaces, are ground and are available with a rough surface in different slab, ashlar or column formats in the specialist building trade. There appearance is substantially influenced not only by the additives used but also by any surface machining carried out. However, natural stones embedded in the shaped concrete element are also known, e.g. from EP 0 566 084-A1.

A composite shaped block produced from a concrete element with a trough-shaped recess and a natural stone slab placed on it, with a stepped bottom, is described in EP 0 717 147-A1. The section of the stepped bottom projecting from the edge engages in the trough-shaped recess. The disadvantage of this is that the natural stone slab must be bevelled in the edge region and must be subjected to another material-removing machining stage. Such machining stages cannot be carried out with the required precision, which would otherwise necessitate overdosing the quality of adhesive because it cannot be determined exactly. Excess adhesive retards the setting process and, in particular, makes it difficult to position the natural stone slab precisely in relation to the concrete element.

Natural stones exhibit a different thermal expansion and water absorptivity from concrete. When laid in external areas these materials are exposed for decades to extreme weathering influences, for instance high temperature differences, frost/thawing cycles and permanent dampness. Consequently the adhesive layer of a composite material, e.g. a composite material of natural stone and concrete, must be capable of permanently compensating for the flexural tension, shearing and compressive forces resulting from the different coefficients of expansion of both materials and those resulting from the mechanical loads with continuous elasticity. Furthermore, the adhesive layer must not swell by permanent moisture or dampness and lose their adhesivity if they are to guarantee a permanent combination of even the most varied of materials over decades.

The object of this invention is to utilise the advantages of a concrete material, whilst at the same time eliminating its disadvantages, but in particular to make available shaped blocks with head faces having a high aesthetic value in a rich variety of colours and structures.

This object is achieved by the composite shaped block according to claim 1. Advantageous developments and designs of the invention are possible if the measures referred to in the sub-claims are taken.

The invention relates to a composite shaped block manufactured by the application of an upper slab as covering top layer to a support element provided with an agglomerant and manufactured by means of a shaping process. The upper slab and support element are permanently connected to an agglomerant that is applied in a pasty consistency, preferably containing minerals, then solidified, by means of the head face of the support element, wherein the head face of the support element is preferably provided with a peripheral edge, and the head face is structured in a defined manner for optimum absorption of the agglomerant.

The upper slab is preferably 0.5 to 3 cm thick. Head and base surface of the upper slap are preferably plane-parallel all over the surfaces.

The support element is preferably 2 to 16 cm thick, but may also be up to 20 cm thick, for example, and ca be manufactured in a wide variety of volumetric expansions, but it should preferably be cuboid in shape, wherein the head and base surface of the support element should preferably form essentially plane-parallel surfaces. The lateral faces should preferably be aligned approximately perpendicularly to the head face.

The agglomerant forms an intermediate layer which is essentially limited on the outside by the support element and upper slab on all sides.

The lateral faces of the composite shaped block according to the invention may exhibit cams (bulges) and also recesses so that the cams of a composite shaped block when laid in the composite engage in corresponding recesses of adjacent composite shaped blocks as lateral offsets. If corresponding recesses are not provided for this engagement, the cams act as spaces when laying in the composite and as transport protection.

According to a further embodiment of the invention the support element is provided in all corners with cams which form an additional support at the statically weakest point of the upper slab (corner). The cams preferably have a semi-circular shape, in the plan view, act in the composite as a spacer for forming a uniform joint, and protect the corners.

The lateral offsets, in conjunction with the above-mentioned “corner shapes”, may form positive connections which are made two-dimensionally or by means of inter-locking offset elements, possibly in the form of positively interlocking spaces on the lateral walls. Intervals or joints can be created between the laid paving stones with the aid of the spacers to provide secure wedging or denticulation between the stones and better drainage of the laid surface.

The cams and the additional recesses provided also facilitate precise laying in the composite and ensure uniform distances between the joints, a durable joint and additional stability in the paving composite. The high resistance to distortion/tilting is particularly advantageous in the case road surfaces with high horizontal stresses (gradients, etc.).

The offset provides a better overall connection of the laid surface than materials where no offset is provided. The offset should preferably be designed so that it also provides the space for the subsequent joint of the laid surface and also acts as transport protection.

The cams may be constructed throughout the height of the support element and even extend, optionally, beyond the total height of the support element in the direction of the upper slab, e.g. 1 to 6 mm, preferably 2 to 4 mm, above the total height of the support element, and then preferably as a lateral stop and for centring the upper slab. The section projecting above the total height should preferably be bevelled, and should preferably be constructed at an angle of 40 to 60° so that it is not visible in the joint pattern. The spacer is angular in shape in this section which is raised above the support surface, the shorter leg of the angular shape preferably lying flat on the upper slab.

The support element preferably exhibits spacers (cams) on the lateral surfaces. These spaces are arranged vertically at different points of the support surface so that the composite shaped blocks can be laid in different bonds (for example a stretcher, cross or herringbone bond). The spacers are designed in different thicknesses, widths and shapes, depending on the dimensions of the composite shaped block, its height and the purpose for which it is being used. The spacers prevent the upper slabs from pushing together both during transport and during laying, and ensure that when the blocks are laid, a minimum joint dimension is adhered to and the joints can be expertly filled. The spacers/cams may also be designed so that they are provided with a theoretical fracture point. This ensures that the desired joint width is produced during laying, but at the same time it prevents permanent concrete to concrete contact. Instead the spacers break when loads are exerted on the theoretical fracture point and the joint filling material takes over the functions of force transmission and buffer action, as provided for in the design.

In the position of use the support element forms the lower bearing course of the composite shaped block. The support element should preferably consist of concrete but may also be manufactured from other suitable materials such as plastic, metal, wood, clay/ceramics or hybrid mixtures or may be of a sandwich structure.

The support element provides the upper slab with the required breaking strength and service strength, in particular compressive and flexural tensile strength, and should be selected so that it is much less expensive to produce than the upper slab material in terms of its material value. The support element is manufactured from a material that can be poured, shaken or sprinkled in a shaping process.

The support element may be shaped so that several support elements or composite shaped blocks can be stacked one inside the other, which saves on transport and storage costs. Furthermore, the support element can be provided with cavities in which supply pipes, illuminating / lighting elements and heat carriers can be fitted.

The support element may be shortened on the base side, accurate to one millimetre, to the required final thickness by sawing, calibration or other machining operations. Different thicknesses of the support element may be produced if the upper slabs applied exhibit different thicknesses.

It is also possible to reinforce the support element on the base side in a final stage to provide the required constant overall height with different upper slab thicknesses, possibly by applying a further concrete course.

However, the support element may also be manufactured from plastic material, in particular from recycled plastic waste material. The composite shaped block, on which it is possible to walk or ride, consisting of a plastic support, intermediate layer and mineral upper slab, is then many times lighter than conventional mineral moulded elements despite essentially the same technical values in terms of compressive strength and flexural tensile strength.

The plastic material used may be manufactured from mixed plastic fractions which are either pre-pelleted as so-called pellets for further processing or are mixed by means of a so-called impact reactor or otherwise prepared for injection moulding. The core may also be produced from sorted or unsorted plastic waste. The different geometric shapes of the support element may be produced from “simple” and low cost injection mouldings, which also makes shaping generally less expensive than pavings of solid natural stone.

To increase stability generally a suitable counter-moulding is inserted in the base side of the plastic support element to produce a closed laying surface. This counter-moulding may be produced positively so that an airtight space is created to provide the insulation action which, assuming corresponding weathering, reduces the formation of frost on the top of the slab and therefore the risk of accidents, among other things.

Cavities may be heated by suitable measures, for which purpose it is possible to provide the counter-moulding with heating wires, for example, or to heat it by other thermal means. The energy required can be supplied by suitable interconnected plug-in systems, and the pavements can therefore be heated favourably and efficiently. A lighting device can be installed in the plastic core, and the core itself, together with the upper slab of a mineral material, can be designed so that they are translucent.

Because of the geometrical shape of the plastic core it is possible to minimise the thermal expansion of the plastic core.

The finished pavement has considerable advantages over conventional pavements for greater structural heights (from 3 cm) because it is lighter and sawing, drilling and other machining operations can be carried out more easily, with greater cost savings. Furthermore, it feels more pleasant to walk on than pavements consisting solely of mineral materials.

Concrete is produced from a mixture of cement, grains of rock—also known as concrete aggregate—and water, together with other additives optionally, by heating the “cement paste” (=cement+water). As “fresh mixed concrete”, with an optional consistency range, the concrete can be poured or shaken/pressed into any shape and structure. The support element, after setting, exhibits a compressive strength generally ranging from 25 N/mm² to well over 60 N/mm².

Mixtures of unbroken and/or broken grains of natural and/or artificial mineral substances are used as rock grains, e.g. different sizes of grains of sand, gravel, chippings, broken stones, swelling clay or swelling slate (lightweight concrete), slags and/or iron oxide.

Furthermore, conventional additives such as plasticizers, air-entraining agents, (dye) pigments, concrete densifiers, setting accelerators, setting retardants, stabilisers, liquefiers, fluxes, injection aids, micro- and nanosilica, rock flours, plastic dispersions, fibres and/or chromate reducers may be added.

If cement and water are mixed to form a paste, this paste gradually solidifies. The cement paste develops into cement block by stiffening (setting) and heating. This solidification relies upon the formation of water resistant (hydraulic) compounds.

There are a number of possibilities for densifying the concrete, such as reinforced stamping, stirring and shaking. The support element may also consist of reinforced concrete, i.e. reinforcing inserts (round steel, steel mats, fibres, non-woven fabrics, etc.). Whilst the concrete exhibits compressive strength, the steel or other components mentioned, with greater tensile strength, absorb the tensile stresses that are generated.

The volume of the concrete changes as a result of creep, shrinkage and seasonal temperature fluctuations. A structural element 10 m long, for example, experiences a variation in length of around 10 mm per 100 K of temperature difference. This also gives rise to tensile and compressive stresses.

The support element exhibits an upper support surface which is constructed so that it is essentially plane-parallel to the base surface. The support surface is designed as a structured three-dimensional surface, where the structure may take different forms. A common feature of all the surface structures is that they exhibit an outer, convex upper edge along the lateral edges of the support element, and the upper edge forms a support surface that is essentially plane-parallel to the base surface.

Moreover, several convex support faces should preferably be provided in the surface clamped by the outer edge as further contact supports. The upper edge and the convex partial support faces should preferably form a common support surface plane-parallel to the base surface. For this purpose the inner convex partial support faces are designed so that they are, optionally, slightly higher than the edge support faces, optionally lower, but preferably of the same height. The partial support surfaces may possibly be pyramidal, hemispherical or conical in shape or, less preferably, they may be designed as corrugated, zigzag or groove-shaped elevations. The partial support surfaces form fixing points for the upper slab to be installed and prevent lateral or vertical tilting and displacement of the upper slabs. The actual support face of the partial support faces preferably has an area of less than 2 cm², in particular less than 1 cm² or even less than 0.5 cm. Limited by the edge, at least 4, preferably over 12 partial support faces may be distributed over the trough-shaped recess. The support face is understood to refer to the surface in contact with the upper slab, including any agglomerant between the upper slab and the support face in a thickness of up to three times the mean granulation of the agglomerant.

Because of the defined structured natured of the surface, a calculable recess volume and a larger area are provided for adhesion/connection to the upper slab, and because of the inner support surfaces higher shearing, flexural tension and compressive stability is ensured to enable the forces generated by walking and transport to be absorbed and the different coefficients of expansion of the materials to be used to be taken into consideration as far as possible.

The height of the partial support surfaces and their geometry enable the volume of adhesive to be applied to be calculated and prevent agglomerant surpluses so that agglomerate does not escape in an undefined manner from the lateral faces when the upper slab is placed on the head face of the upper element, and when there is nevertheless uniform distribution in the trough-shaped recess, in which case the partial support faces must also be provided with agglomerant when it is applied.

In addition, because of the small contact area and the large number of support faces an accelerated setting process is deliberately initiated at the tips of the partial support faces, which process ensures immediate fixing of the upper slab installed. This guarantees that the composite block can be transported and further machined immediately after the upper slabs are installed without the upper slabs being displaced from the defined point of contact as the working process continues or being loosened from the composite.

Unlike the methods of prior art, the aforementioned characteristics provide the possibility of producing a composite shaped block on an industrial scale in the cycled production process, and also of calculating exactly the volume of adhesive to be applied. The partial support faces also enable the composite blocks to be stacked without the agglomerant having to set completely.

However, the peripheral outer edge of the support surface also be opened according to a further embodiment so that the agglomerant can be discharged at a defined point. The openings may possibly exhibit penetration areas of the order of 0.2 to 1 cm². The support element should preferably only exhibit 1 to 6, in particular 1 to 3 openings on each of its lateral faces.

The partial support faces may also be subsequently applied to the surface outside the production process of the support element or installed in the support element and exhibit the same geometries as described above.

The coat thickness of the agglomerant should preferably be on average 2 to 12 mm, and in particular preference 2 to 5 mm.

It is also possible to provide the support element with further cavities extending from the head face in the direction of the base surface, preferably to a depth of ⅔ of the total thickness of the support element. The cavities serve to save material and weight and also receive excess agglomerant, which has a positive influence on the adhesive joint. For example, the total volume of all the recesses/cavities may constitute 5 to 75% of the total volume of the support element.

The other cavities extending in the direction of the base surface may be shaped so that they widen in diameter as they extend downwards, resulting in an upward penetration of the agglomerant, causing it to form a paste at the bottom and wedge tight after setting.

Furthermore, cavities in the shape of troughs are installed in particular preference in the trough-shaped recess. The volume of the troughs may, for example, range from the same volume as the partial support faces up to 50%, preferably 5 to 15% less than this volume.

It is also preferred if the troughs are distributed in the same field as that of the elevation, i.e. each partial support face exhibits an average of at least half a trough, adjacent to it, in order to shorten the path of the agglomerant when the upper slab is installed. The adjacent trough preferably has 0.2 to 1 times the volume of the partial support face.

The cavities, particularly those extending from the head face to the base face, should preferably not be completely filled with agglomerant, so that cavities are left which act as a buffer against thermal material expansion.

In the process of manufacturing the support elements the surface geometry of the support face of the support element, including the cavities extending in the direction of the base face, may simply be determined by the type of top ram used. Optionally, two top rams are used, one for forming the cavities extending to the base face and one, preferably after the first, for forming the structured support face. The support element provided with further cavities enables weight and material savings to be made, unlike the solid element. Such a support element may also be used solely as a paving stone.

The upper slab, as the top covering layer, may consist of fine vitrified clay, ceramic and/or natural stone, as well as other materials such as glass, wood, rubber, metal etc. It should preferably be cuboid in shape.

The upper slab, particularly one of materials with finished shapes, may exhibit different geometric shapes for engaging with the binding additive and support element on the base head side, the base side preferably being planar in design and, optionally, exhibiting a certain roughness.

The connecting surface may also be machined by mechanical roughening, such as bush-hammering, blasting, chiselling, milling, planning etc. to achieve an enlarged adhesion area.

Natural stones include, of course, stones produced from different basic components such as limestone, dolomite, sandstone etc. Suitable natural stone materials include: vulcanites such as granite, syrenite, diorite, gabbro, basalt, diabase, rhyolite, trachyte, sedimentites such as psephites, conglomerates, breccia, sand rocks including the lime sandstones, slate, travertine, dolomite stone and shell marl, as well as metamorphites such as orthogneiss, quartzite, mica slate, phyllites and paragneisses.

Granite is one of the most commonly known and important plutonic rocks, and consists of feldspar, quartz (20-40/50%) and mica (0-10%). Mica provides granite with contrast and ensures a certain schistosity of the rock, and feldspar and, in particular, quartz, ensures hardness. The proportion of feldspar determines the colour of the rock.

“Diamond quartzites” are schistous materials, over 80% of which are available in stratum thicknesses of between 1.0 and 2.0 cm, and whose rich deposits can be worked in open-cast mining. Quartzite belongs to the group of natural stones with the highest degree of hardness. The natural stratum thicknesses and roughnesses of the quartzite surfaces require no further machining for producing the composite stones according to the invention, and only the normal material cutting need be carried out. On the one hand the surface roughnesses meet all the conditions for a permanent joint, and on the other they provide a permanently slip resistant, hard wearing floor covering surface.

Other natural stone deposits of similar hardness, e.g. granites, can only be worked by the block method. Granites must be sawn into slabs with diamond or reciprocating frame saws, and both surfaces must be mechanically re-machined for use as an upper slab.

The upper slab should preferably exhibit the following length (longest side) to thickness expansion: greater than 3 to 1, in particular greater than 5:1. The slab may be produced by splitting or machining, such as sawing.

Fine vitrified clay is a thoroughly sintered, artificially produced ceramic product. It is very compact and also exhibits a very low porosity, from which it derives special mechanical and chemical properties, e.g. frost resistance. In other words, it is a product which can also be used to advantage for wall and floor coverings in outdoor areas in cold climatic regions. Moreover, fine vitrified clay is highly resistant to chemicals and detergents, it has a very high abrasion resistance and a high breaking strength. This renders it ideal for surfaces subject to intense public traffic and in industrial plants. In addition to this it is easy to clean.

The search for new finishes has resulted in a number of different treatments for the end product, e.g. polishing, which has been given rise to two different types of product: natural and polished fine vitrified clay. The natural type (receives no subsequent treatment after firing) has a natural appearance and to some extent even imitates stones which can be found in nature, such as slate, marble, paving stones, etc. In the case of polished vitrified clay the material is polished after firing to give it a high gloss and imitate the surface optics of polished marble.

The upper slab may be surface refined by the method described in European patent EP 1 124 774 and EP 0 825 917-B1 (corresponding to U.S. Pat. No. 6,167,879). The disclosure content of these rights of protection is hereby made the subject of this application by reference to it.

A dirt repellent, slip resistant surface, which has varied applications as a floor and staircase covering, is provided by the special surface treatment of the head side of the upper slab, including laser treatment and, optionally, combined with subsequent impregnation treatment, or by only one impregnation treatment. Surface treatment may be used, in particular preference, for natural stone surfaces.

In addition to water and rock grains, the agglomerant contains at least one binding additive. The binding additive should preferably be an aqueous polymer dispersion, optionally used together with a cement binding additive. The agglomerant sets through contact with moisture.

Principal components of the agglomerant in terms of weight, after drying, are rock grains, e.g. fine sand, particularly quartz sand with a granulation of 0 to 2 mm, particularly 0 to 1.0 mm. Furthermore, a cement, possibly Z325 Portland cement, is advantageously added.

The agglomerant is applied to the head side of the support element, preferably flatly or in the form of pasty, in particular pasty flat beads, and in particular over the entire width of the support face or at defined points, the head side of the support element exhibiting partial support faces and the deposit areas for the agglomerant being limited by the outer partial support faces. The upper partial support faces adjacent to the lateral faces of the support element can also be covered with agglomerant, e.g. adhesive mortar. Expulsion of the agglomerant applied, when the upper slab as a top covering layer is placed on the support element, is prevented/reduced or defined both the accurate calculation of the volume of the agglomerant ad by the, outer partial support faces, where openings are provided for this purpose. As far as the inner cavity volume formed between the outer partial support faces and plane-parallel sealing face of this edge support is concerned, the volume of agglomerant applied should preferably be at least equal to the inner volume of the upper cavity (except the cavities extending in the direction of the foot face) to ensure that a solid adhesive joint is provided, to the exclusion of concavities.

The agglomerant may also consist of acrylate, one- and two-component polyurethane, thermoplastic, duoplastic or epoxy compounds, which may also be reactive, for example, depending on the material of the support element.

The aqueous polymer dispersion is suspended/dispersed in water and preferably a polymer which exhibits, in addition to styrene and/or butadiene units, at least one polar monomer or polar groups, e.g. carboxyl groups, e.g. in the form of acrylate, methacrylate or vinyl acetate groups/monomers. For the hydrolysis resistance it is important for the polymer to exhibit a carbon chain as a backbone (carbon back-bone) which carries polar side groups.

Vinyl acetate terpolymers in aqueous dispersion, carboxylated butadiene-styrene-methacrylate-polymer lattices or polyurethane dispersion are also suitable, for example.

The composite shaped block may exhibit the shapes that are normal in the state of the art, for example cube, binder or one and a half, double block, prism block, head or mitre shape. The composite shaped block according to the invention is preferably used as a paving element for external installations such as footpaths, roadways and terraces and as a double floor system for interior areas, but can also be used, with its described advantages, as a facade element. to advantage.

It is laid in the composite as a paving surface on a bed, preferably by the filling of joints. In addition to normal mineral filling materials, the jointing compounds used may also be those which contain cement, bitumen as agglomerant and/or additions of plastic agglomerants.

A composite of the blocks is influenced by the geometry of the paving stones, and loosening of individual blocks is prevented by the action of live loads and forces from traffic. The composite shaped blocks according to the invention could possibly be laid in a series, herringbone or twill joint, scalloped arches, diagonal joint, block or parquet joint, cross joint, stretcher joint or in the Roman joint.

In contrast to natural block paving, the composite shaped block according to the invention can be laid on a prepared paving bed and does not require a bed in which it is aligned with a paving hammer to correct for surface smoothness.

The composite shaped blocks according to the invention may also be used as an outer covering material that can be walked or ridden on for maximum surface loads, and constitute a product which can be laid as easily as a concrete stone or concrete ashlar. The covering can also be easily laid by the inexperienced handyman.

The composite shaped block may also be used in exterior and interior areas as a substitute for concrete ashlar slabs. The total thickness may be between 2 and 7 cm, according to the application, the upper slab preferably exhibiting a thickness of less than 1.3 cm.

The composite block slab may also be produced in total thicknesses of below 3 cm for interior areas or for the use of terrace slabs, etc., so that it can be provided with a fine vitrified clay upper slab, which cannot yet be produced as a solid material in thicknesses of over 1.5 cm, or can only be produced at high technical and financial cost.

A further object of the invention is to provide an industrially useful, cycled mechanical method for manufacturing the composite shaped blocks according to the invention. This object is achieved according to the invention by means of the method characteristics identified in claim 21. Preferred embodiments form the subject of claims 22 to 27.

A defined volume of concrete is prepared on a vibrating table in a moulding frame which corresponds to the support element to be produced, and is compressed by shaking and shaped to the head face by means of a die.

The shaking forces may be applied by a method that is well known in connection with concrete stone moulding machines, i.e. by shaking the mould and/or the die, but preferably by shaking vibrations of the vibrating table and/or by shaking of a superimposed die load. The shaped block may also be compressed by pressing or stamping using methods normally applied in industry.

The support element, here the support face for the upper slab, is preferably moistened with water before the agglomerant is applied. A polymer, as defined above (under aqueous polymer dispersion), can be added to the water in the weight ratio of 1:9 to 1:50, to improve the adhesive action. The polymer is preferably sprayed on using a dosing device.

The die contours the head face of the support element and, in particular, embosses the peripheral edge and the partial support faces by means of recesses in the die, which edge serves as a support face for the upper slab. If required the further cavities (troughs) extending in the direction of the base face are produced by the same or another die. For this purpose finger-shaped, cylindrical or tapered pins are preferably mounted on the die face and are inserted in the concrete mass as the die is lowered. They are preferably aligned in the direction of the surface perpendicular of the die face.

Shaping may be carried out by raising the moulding frame and/or the die. The die face may be freed from concrete residues adhering to it after the stamping process and after a number of stamping operations.

The shaped and dimensionally stable support element is covered on the surface with a pasty agglomerant, preferably by means of dosing nozzles under which the support element is moved through with the trough-shaped head face facing upwards. The agglomerant is applied flatly to the head face of the support element, preferably omitting the peripheral edge, particularly in an essentially uniform coat thickness, preferably between 2 and 5 mm, the application height of the agglomerant exceeding, independently as a further preference, the height of the partial support faces of the head face of the support element by no more than approx. 0.5 mm.

Before the agglomerant is applied it may be advantageous to moisten the support element in order to provide positive support for the subsequent stage of the adhesion. For this purpose the spray water can be mixed with the polymer of the adhesive binder, preferably in the ratio 20 (water) to 1 (polymer). The agglomerant consists of different mineral substances (quartz sand, cement), as well as mixing water and a polymer additive, which are mixed together in a so-called forced mixer before application to the support element, then transferred from the mixing tank to a storage tank with a slowly rotating agitator for further processing. During transport of the mixed agglomerant it must not be excited by pressing or compression for the purpose of separating out the solids and liquids. This is guaranteed by the combination of suitable pumps and suitably dimensioned transfer pipes, in terms of volume.

The upper slab and support element are then lowered one on top of the other, flush with the lateral faces, and are brought closer together preferably with slight rotation about the axis of approach, or even with light vibratory movement (vertically) along the axis of approach. The support element is preferably conveyed in cycles to bring together the upper slab and support element. The head face area of the support element preferably exceeds that of the base face of the upper slab slightly, e.g. by an average of 0.5 to 2 mm on all sides.

The upper slab can be centred with the support face by previously measuring the support element and positioning it correspondingly on the basis of the transmitted data.

The upper slab may be guided by a grab, in particular a strainer grab, and stationary roller elements or guided pressure elements can then be used for subsequently fixing or pressing on the upper slab. For fast setting the composite shaped block may then be subjected to thermal treatment, preferably by conveying the composite shaped block to a space whose temperature is set to 90 to 150° C., ideally to 110 to 130° C., e.g. a “paternoster” or a “setting tunnel”.

If required, the upper slab can be provided with an impregnating agent which penetrates well into the generally highly structured surface. For this purpose the impregnating agent is sprayed onto the surface of the upper slab before the slag enters the drying tunnel.

To support this the upper slabs can be heated before being placed on the support element, preferably to approx. 30° C. to 45° C., which may also be advantageous in terms of the adhesive joint and improve the subsequent impregnation action, since the impregnating agent soaks much better into a tempered surface. Heating may be carried out, for example, in a stacking/storage device before the upper slab is positioned on the support element.

In particular preference an aqueous dispersion of a silicon-organic compound in water is used as an impregnator. The purpose of such a composition may also be an additional dispersing aid. However, the silicon-organic compound may also be absorbed in a hydrocarbon medium such as test petrol. A dispersion of an alkylalkoxy silane and a fluorine polymer in water has proved extremely advantageous as an impregnating agent.

However, the impregnating agent may also consist of an aqueous dispersion of an acrylate polymer. The impregnator is preferably applied by a dosing device, with flat application of the impregnator/impregnating composition, preferably by spraying. However, it may also be applied by other methods, e.g. rolling.

After the impregnator is applied treatment may also be carried out by thermal heating, microwaves, UV or IR radiation, resulting either in recrystallisation of the surface in mild temperatures, or fusion of the silicon-organic compound with the carrier material at high temperatures. According to a preferred design of the invention a limit temperature of 75° C., for example, is not exceeded on the surface of the mineral material. The prescribed process can be repeated several times, e.g. there may be a second or third impregnation of the upper slab surface at the exit of the so-called “drying tunnel”.

An increased adhesive and shearing action can be achieved and a defined surface geometry can be produced by using a facing as a support face of the concrete core, e.g. using natural stone chips. This layer can be tempered by additives, e.g. can be provided with water permeability, to guarantee fast drying of the surfaces (after laying and in wet conditions) and to prevent moisture from migrating from the concrete core in or through the adhesive layer or surface.

One advantage over solid natural stone provides the possibility of simple shaping of concrete cores—oval, round, angular, including incisions, all current geometric shapes are cost effective or possible, in any case, unlike solid natural stone. At present geometric shapes, apart from actual shaping, which can be produced with saw blades (straight cuts), can only be achieved with expensive water jet cutting and only to a depth of approx. 3 to 5 cm (stone-dependent) or by a stone mason. According to the invention the upper slabs may generally be only 1 to 2 cm thick, and the support element (concrete core) can be produced cost effectively by shaping to any shape and height.

It is also possible to provide the composite block as a drainage block. By making conical cavities in the support element and corresponding openings accurately machined in the upper slabs, a useful water repellent coat can be produced.

Furthermore, it is possible to provide the upper slabs with luminous or display elements, e.g. by optical fibre cables.

According to a preferred production variant, the support element is manufactured from “finer” facing concrete, sealed at the top, to obtain a surface that is more dimensionally accurate than conventional concrete surfaces. An “upper concrete”, which offer several advantages, is applied to the core as the uppermost layer. The upper layer can be produced to improve the adhesive joint (system in system solution), it can be made waterproof (faster drying, prevention of water stains, faster thawing in the case of ice and snow) and it can be made more dimensionally accurate, for better design of the troughs or elevations, as opposed to conventional concrete. Small troughs on the highest points of the elevations can ensure that the agglomerant forms an extremely thin layer there so that the recesses for receiving transverse forces can be used immediately after joining. This enables the composite elements to be stacked immediately after joining without any displacement of the cover or top slabs.

The invention is explained in the figures, where:

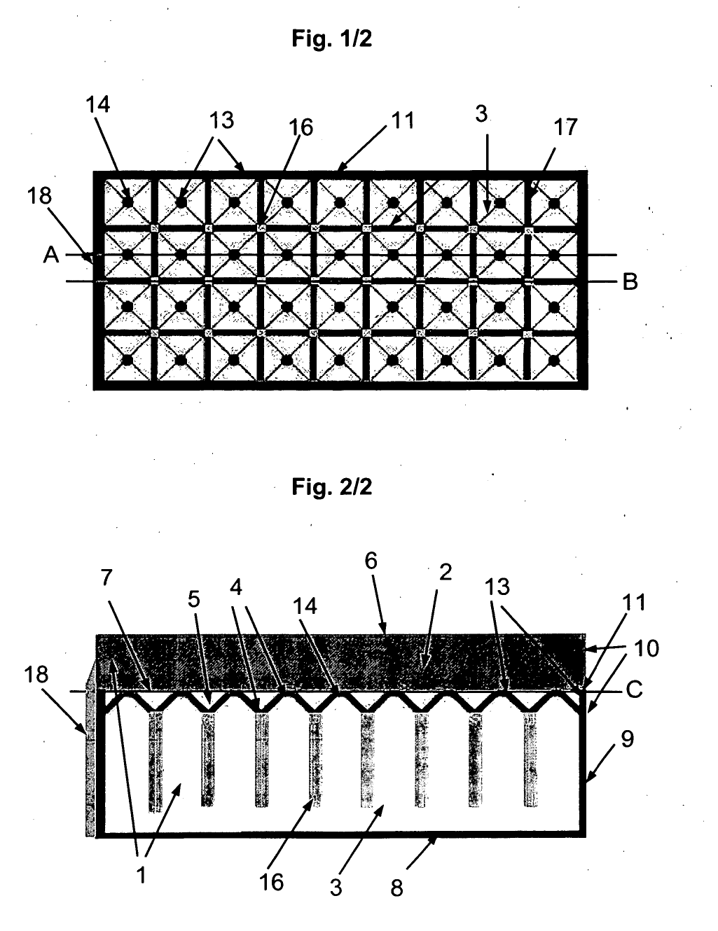

FIG. 1 shows a plan view of the head face of the support element

FIG. 2 shows the composite shaped block with support element and upper slab along section A in FIG. 1, the cavities (16) lying in plane B also being shown in FIG. 2 for the sake of simplicity. FIG. I shows a plan view of the surface shown as C in FIG. 2.

On the lateral faces (9) of the support element (3), the support element (3) exhibits a peripheral edge (11). The edge (11) forms a trough shape on the head face (4). The upper rim of the edge (11) is designed as an edge face (12) as a surface which is plane-parallel to the base face (8) of the support element (3), the large number of punctiform partial support faces (14), together with the edge surface (12), forming the support face (13) for the base face (7) of the upper slab (6).

The punctiform partial support faces (14) form part of the pyramid structure formed on the head face (4). Instead of a pyramid structure, other structures/contours are possible, such as troughs or zigzag enclosures. The pasty agglomerant is deposited in the cavities (17) and is pressed into the remaining volume of the upper cavities (17) after positive positioning of the upper slab (2), these cavities being essentially fully filled. The cavities (16) extending in the direction of the base face (7) only partially absorb agglomerant and serve, among other things, as a volume buffer for the agglomerant.

By way of example a cam (18) is shown on the lateral wall of the composite block, the length of this cam exceeding the height of the lateral face (9) of the support element, but is less than the height of the lateral wall (10) of the composite shaped block and lies flush with the length of the upper slab (2) projecting from the support element. The tip of the cam is chamfered outwardly at an angle of 45°. This is a special design. Generally such an excess length is not required.

1. Composite shaped block (1) exhibiting an upper slab (2) as a covering layer, and a support element (3) manufactured by a shaping process, with head face (4), wherein
the upper slab (2) and the support element (3) are permanently connected by the head face (4) of the support element,
the support element (3) is provided on the head face (4) with a an agglomerant applied and solidified, and
the head face (4) of the support element (3) is designed in the shape of a trough to receive the agglomerant.

2. Composite shaped block according to claim 1, characterized in that the upper slab (2) exhibits a thickness of 0.5 to 3 cm and, independently of this, the base face (7) of the upper slab (2) forms a planar surface and, in particular, head (6) and base face (7) of the upper slab (2) form an essentially plane-parallel surface.

3. Composite shaped block according to claim 1 characterized in that the head face (4) of the support element (3) stamped so that it is trough-shaped exhibits several convex partial support faces (14) as contact supports in the surface claimed by the outer edge.

4. Composite shaped block according to claim 1 characterized in that the head face (4) stamped in the shape of a trough exhibits partial support faces (14) with supporting faces aligned plane-parallel with the base face (7) of the upper slab.

5. Composite shaped block according to claim 1 characterized in that the head face (4) stamped in the face of a trough exhibits partial support faces (14) designed according to one or more of the three alternatives:
partial support faces (14) are roughly as high as the edge support surface (15),
partial support faces (14) are preferably a maximum of 6 mm, and in particular a maximum of 2 mm higher than the edge support surface (15),
partial support faces (14) are a maximum of 2 mm lower than the edge support surfaces (15).

6. Composite shaped block according to claim 1, characterized in that the head face (4) stamped in the shape of trough exhibits partial support face (14), wherein at least 4 of the partial support faces (14) maintain between them at least a distance which is greater than ⅓ of the longest edge distance, and at least each of the 4 partial support faces (14) lies in one of four coherent partial surfaces of the same size as the trough surface, and wherein, as a further preference, each of the 4 partial support surfaces (14) has a distance of a least ⅓ of the longest edge distance from the edge (11).

7. Composite shaped block according to claim 1 characterized in that the base face (7) of the upper slab (2) is smaller in area than the head face (4) of the support element (3).

8. Composite shaped block according to claim 1 in that the support element (3) exhibits a thickness of 2 to 20 cm and, independently of this, the head (4) and base face (8) of the support element form essentially plane-parallel surfaces.

9. Composite shaped block according to claim 1 characterized in that the set agglomerant forms an intermediate layer between support element (3) and upper slab (2), which layer is limited outwardly and essentially on all sides by the support element (3) and upper slab (2).

10. Composite shaped block according to claim 1 characterized in that adjacent lateral walls (10) of the composite shaped block in the region of the corners of the support element exhibit cams (18) which lie at a distance from the lateral walls (1), in their extent, of at least the length of the excess length of the upper slab (2) in the corner in order to serve as a further support face and/or impact protection, and in that the cams (18) project preferably by an average maximum of 5 mm, preferably a maximum of 3 mm from the surface perpendicular on the lateral wall (10).

11. Composite shaped block according to claim 1 characterized in that the lateral walls (10) of the composite shaped block, preferably in the region of the support element (3), exhibit cams (18) or spacers and, optionally, also recesses.

12. Composite shaped block according to claim 1 characterized in that the support element (3) forms the lower bearing course of the composite shaped block (1) in the position of use.

13. Composite shaped block according to claim 1, characterized in that the support element (3) is manufactured from a material that can be shaken, sprinkled or is able to flow, by means of a shaping process, and in that the material consists of plastic, concrete, metal, wood, clay/ceramic or their mixtures, preferably concrete.

14. Composite shaped block according to claim 1 characterized in that the head face (4) of the support element is designed to form a support face (13) for the upper slab (2), wherein the head face (6) exhibits a convex edge running on the outside along the upper edge of the lateral face (9) of the support element, in order to form one or more troughs for receiving the agglomerant, and wherein the upper edge surface (12) forms a support face (13) essentially plane-parallel to the base face (8).

15. Composite shaped block according to claim 1 characterised in that the head face (4) clamps, inside the peripheral convex edge (11), a surface which exhibits several inner, optionally also punctiform, partial support faces (14) for the upper slab (2), wherein the partial support faces (14) are designed so that they are no higher than the edge support faces (15), preferably the same height.

16. Composite shaped block according to claim 1 characterized in that the support element (3) is provided with further cavities (16) extending from the head face (4) in the direction of the base face, preferably down to a depth of ⅔ of the total thickness of the support element (3), wherein, independently of this, the total volume of all the recesses/cavities (16, 17) constitutes preferably 5 to 75% of the total volume of the support element (3).

17. Composite shaped block according to claim 1 charactcrised in that the upper slab (2) consists of fine vitrified clay, ceramic, materials such as glass, wood, rubber etc. and/or natural stone.

18. Composite shaped block according to claim 1 characterised in that in addition to water and rock grains, the agglomerant (5) contains at least one binder, wherein the at least one binder is an aqueous polymer dispersion which is preferably produced using styrene and/or butadiene units as monomers, and exhibits a polar monomer or polar groups, and the binder preferably also incorporates a cement and sets on contact with moisture.

19. Composite shaped block according to claim 1 characterised in that the agglomerant (5) has a pasty consistency.

20. Composite shaped block according to claim 1 characterised in that the head face (4) exhibits a trough shape and the peripheral convex edge (11) exhibits openings, preferably 1 to 3 openings for the defined discharge of excess agglomerant (5) spaced every 10 cm of the lateral face of the support element (9).

21. Method for manufacturing composite shaped blocks (1) exhibiting an upper slab (2) as the top covering layer and a support element (3) exhibiting a head face (4) and manufactured by a shaping process, wherein the upper slab (2) and the support element (3) are permanently connected by the head face (4) of the support element and the head face (4) of the support element has a trough shape for receiving the agglomerant, and wherein the method comprises the following steps:
pouring concrete into a mold frame, corresponding to one or more of the support elements to be manufactured,
trough-shaped contouring of the head face (4) of the support element by a negative mold, wherein the negative mold is a contoured die or a contoured base plate of the mold frame, or by a milling process or a drilling process, optionally associated with the insertion of spacers,
application of the pasty agglomerant (5) to the head face (4) of the support element (3), and
aligned, precise bringing together of the upper slab (2) and the support face (13) formed by the head face (4) of the support element.

22. Method for manufacturing composite shaped blocks according to claim 21 characterized in that, in addition, several cavities (16, 17) extending in the direction of the base face (7) are produced by the die and/or by shapes in the mold frame, and in that they are introduced or produced preferably by pins mounted on the die face of by pulling or insert devices on the die and/or mold frame.

23. Method for manufacturing composite shaped blocks according to claim 21, characterized in that several partial support faces (14) extending from the base face (7) are produced by cavities in the die surface.

24. Method for manufacturing composite shaped blocks according to claim 21 characterized in that the step of applying the pasty agglomerant to the head face (4) of the support element is carried out by means of dosing nozzles, in particular a slotted nozzle, flatly, preferably in the form of flat beads, or defined points, in particularly flatly in the form of a cuboid having a height of 2 mm to 5 mm, in particular 2.5 mm to 3 mm, and/or in that the area peripherally around the edge support faces (15) is smaller than the head face of the support element.

25. Method for manufacturing composite shaped blocks according to claim 21 characterized in that the step of installing the upper slab (2) takes place at least in the region of approach where it is brought into contact with the pasty agglomerant, with light essentially horizontal backward and forward movement along the axis of approach (vertical vibratory movements), and optionally with additional horizontal vibrator movements.

26. Method for manufacturing composite shaped blocks according to claim 21 characterized characterized in that the step of installing the upper slab (2) is carried out by a grab, in particular a strainer grab, which preferably also performs the functions of centering, vibrating with adjustable force and/or pressing with a defined adjustable force.

27. (canceled)
